(19) United States
(12) Patent Application Publication
(10) Pub. No.: US 2023/0042127 A1
(43) Pub. Date: Feb. 9, 2023

(54) A METHOD FOR ASSIGNING ITEMS INTO ONE OR MORE CONTAINERS AND RELATED ELECTRONIC DEVICE

(71) Applicant: A.P. MØLLER - MÆRSK A/S, Copenhagen K (DK)

(72) Inventors: Sajini ANAND P.S., Bangalore (IN); Stefan Otto Theodor GUERICKE, Kongens Lyngby (DK)

(21) Appl. No.: 17/786,552

(22) PCT Filed: Jan. 29, 2021
(86) PCT No.: PCT/EP2021/052183

§ 371 Date: Jun. 17, 2022

(30) Foreign Application Priority Data
Feb. 10, 2020 (DK) PA202070081

(51) Int. Cl. G06Q 10/08; G06Q 10/04

(52) U.S. Cl. CPC G06Q 10/0831; G06Q 10/0838; G06Q 10/047

(57) ABSTRACT

Disclosed is a method, performed by an electronic device, for assigning items into one or more containers. The method comprises obtaining a plurality of attributes associated with a corresponding item. The method comprises obtaining a set of container parameters associated with a corresponding container. The method comprises obtaining one or more constraints, wherein the one or more constraints limit assigning items in a same container. The method comprises determining an assignment of the items to the one or more containers, based on the attributes, the set of container parameters and the one or more constraints. The method comprises outputting, based on the assignment, an assignment plan of the items into the one or more containers.

The present disclosure pertains to the field of transport and freight. The present disclosure relates to a method for assigning items into one or more containers and related electronic device.

### BACKGROUND

According to the World Trade Statistics, millions of loaded containers flow through various shipping lines across the seaports on major ocean trade routes (Trans-Pacific, Asia-Europe-Asia, Trans-Atlantic) every year. Containers are large steel sturdy boxes in standard sizes that are designed for storage and transportation of cargo in an intermodal supply chain. The smallest twenty foot equivalent units (TEU) have a global flow of 127 million in 2014. The intermodal supply chain of the shipping network through which the containerized cargo flow across the globe is considered to be the backbone of the world trade.

Containerized cargo, in general, can include everything from automobile-machinery spare parts to scrap metals and refrigerated cargo as frozen meat, seafood, fruits and vegetables.

Many manufacturers or producers often utilize a logistics service provider (LSP) for the end to end transport of their cargo from the origin (either a manufacturer or a producer) to the final point of distribution (market or a customer), who links their individual supply chains with the logistics network of the shipping lines, thus enabling worldwide marketing and sales of their products. Bookings received by the LSP usually come with a list of attributes on the cargo (vendor, type, relevant book keeping numbers so on) and need to be packed into containers, this process is also called load planning. Cargo consolidation in available containers is a major task of LSPs that is frequently executed for an efficient supply chain management. Once the cargo reaches the warehouse, warehouse managers need to execute the load plan by physically packing cargo into containers. Depending on the setup of the LSP, the load planning can either occur at a planning stage and be executed by the warehouse or can be done by the warehouse directly.

### SUMMARY

While consolidating cargo or items in containers so that total costs is minimized, constraints on both the cargo and the containers need to be respected. LSP may provide the one or more constraints placed on the attributes of the cargo, that limit the number of items that is allowed per container. The process of packing the items into containers honoring all the one or more constraints is also called load planning. In real scenarios, multiple constraints can be placed by the customers and the warehouse managers. For example, customer-specific constraints are that cargo from two different vendors cannot go in the same container or only a limited amount of types can go together—as in apparels cannot go together with shoes and so forth. Further, constraints can be placed for ease of the de-consolidation process, e.g.: items or cargo to different destination ports cannot be packed together in the same container.

There is a need for an electronic device and a method that may address multiple constraints placed on various attributes. Accordingly, there is a need for an electronic device and a method for assigning items into one or more containers, which mitigate, alleviate or address the shortcomings existing and provide, in an efficient manner (e.g. in time, e.g. in computational time), an optimized assignment of items while reducing waste of container space.

Disclosed is a method, performed by an electronic device, for assigning items into one or more containers. The method comprises obtaining a plurality of attributes associated with a corresponding item. The method comprises obtaining a set of container parameters associated with a corresponding container. The method comprises obtaining one or more constraints, wherein the one or more constraints limit assigning items in a same container. The method comprises determining an assignment of the items to the one or more containers, based on the attributes, the set of container parameters and the one or more constraints. The method comprises outputting, based on the assignment, an assignment plan of the items into the one or more containers.

Disclosed is a computer readable storage medium storing one or more programs, the one or more programs comprising instructions, which when executed by an electronic device with a display and a touch-sensitive surface cause the electronic device to perform any of the methods disclosed herein.

It is an advantage of the present disclosure that the disclosed electronic device and method provide, in an efficient manner (e.g. in time, such as in computational time), an optimized assignment of items while reducing waste of container space. The optimized assignment honours constraints while reducing a total container cost.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating schematically a process where the disclosed technique is carried out by an example electronic device according to this disclosure,

FIG. 2 is a flow-chart illustrating an exemplary method, performed by an electronic device, for assigning items into one or more containers according to this disclosure,

FIG. 3 is a block diagram illustrating an exemplary electronic device according to this disclosure, and

FIG. 4 is an illustration of an exemplary method according this disclosure presented as scheme.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

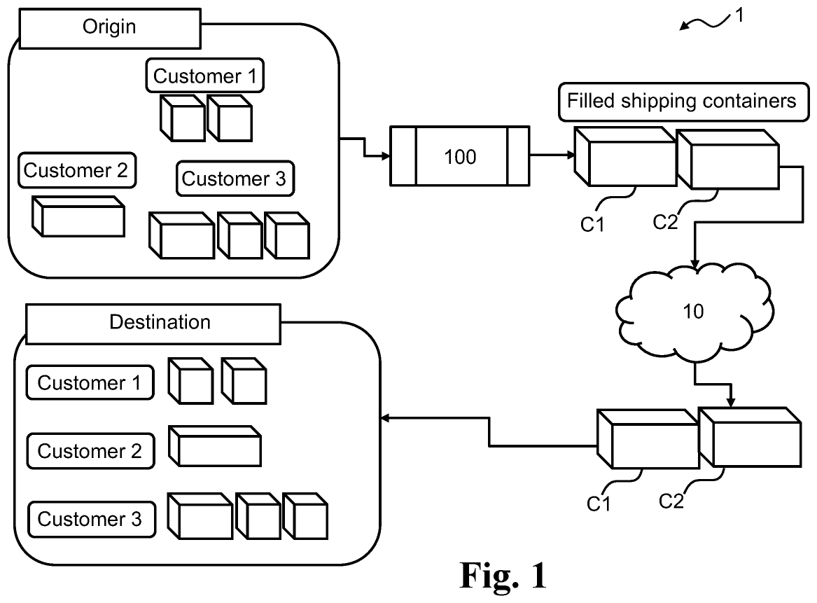

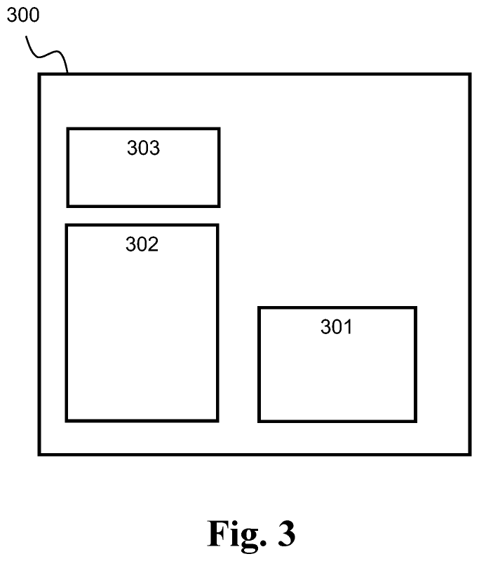

FIG. 1 is a diagram illustrating an exemplary system 1 comprising example containers C1 and C2, a supply chain 10 (such as an intermodal supply chain) and an electronic device disclosed herein (such as electronic device 300 of FIG. 3) configured to perform a method 100 disclosed herein, e.g. to provide the assignment of items according to this disclosure.

As discussed in detail herein, the present disclosure relates to a technique allowing container load planning in an intermodal supply chain.

A container disclosed herein refers to a housing where items to be shipped are enclosed for transport. For example, a container may be seen as a bin. The term container may be used interchangeable with bin in the present disclosure.

An item disclosed herein refers to an object that is to be placed in a container for transport. For example, an item may be seen as an item of cargo, e.g. an item of freight, e.g. an object to be shipped. Note that the terms item may be used interchangeable with cargo. For example, an item may comprise commodities that can be placed into containers, such as goods, such as consumer goods of large manufacturing corporations, generic consumer goods as shoes, clothing, toys and fast-moving-consumer-goods as packaged foods, beverages, toiletries, and medicines.

For example, the items disclosed herein may be seen as commodities that can be packed into e.g. rectangular stackable cartons with variable weights and volumes that are transported in one or more dry containers.

The system 1 described herein may comprise one or more containers C1, C2, e.g. to be filled according to the method 100.

The present disclosure may be seen as addressing a technical problem faced by a Logistic Service Provider (LSP) during the cargo consolidation. The cargo consolidation refers to the process by which a group of ‘less than container load (LCL)’ cargo are consolidated into standard available containers. The process may support to manage the end-to-end transport of the cargo from the origin to destination, e.g. the final point of distribution as illustrated in FIG. 1.

A container freight station (CFS) is a warehouse that is specially used for the consolidation and deconsolidation of cargo into containers for their travel in the intermodal supply-chain. Filled containers from CFS are then trucked to the container yard (CY) and later loaded onto the vessel for its ocean leg. FIG. 1 illustrates the consolidation at origin CFS and the corresponding deconsolidation process at the destination CFS.

Packing the items into available containers as optimally as possible is a task of the consolidation process. For example, an LSP objective may be to pack the cargo honouring multiple constraints on attributes of items such that the cost of the containers used for shipping is minimal.

The consolidation process may take care of the constraints on both the items and the containers. For example, in real scenarios of shipping, multiple constraints can be placed on attributes of items both by the customers and the LSPs. For examples of customer-specific constraints may be e.g.: packages from two different vendors cannot go in the same container, in case of the same type of items more than four different purchase orders cannot go together in the same container, two different types cannot go together, e.g., apparels cannot go together with shoes, and so on. Similarly, some of the constraints on the cargo placed by the LSP for ease of deconsolidation would be of the following types: items to different destination ports cannot be packed together in the same container, items with same plant code attribute can go together. For example, a high priority item is to go in an immediately available shipping slot, or the item should reach the destination before the expected time of arrival, containers that are shipped should be packed within a predefined minimum and maximum container fill ratios. Assignment of items (e.g. cargo allocation) under conflicts may be used as a prerequisite for the load planning process.

An assignment of items to containers (e.g. bin-packing) with constraints (e.g. to avoid conflicts) on the items to be packed in a container is an NP hard problem. The fact that the items have multiple attributes on which constraints are allowed makes the already difficult problem more complex and challenging. The present disclosure proposes a technique that allows finding feasible and/or optimal solutions in a practical time window.

The present disclosure proposes a technique based on e.g. a compact mixed-integer formulation and suggests a heuristic-based technique to address the shortcoming identified.

Approaches (e.g., graph colouring problems, bin packing with conflicts) are focused on regular conflicts which are often between pairs or sets of items. For example, mixed-integer approaches suffer from symmetry due to identical containers and thus long runtimes for practical instances. The disclosed techniques may be seen as based on a heuristic method to address the load planning problem. The present disclosure may be seen as addressing a scenario that requires container packing (e.g. bin packing) with constraints on more than one attribute of an item. The present disclosure may be seen as a container packing technique (e.g. bin packing technique) with multiple attribute constraints on item attributes (which has not been addressed in prior art).

In practical scenarios, several freight forwarders and supply chain network managers frequently face the issue of optimal packing of items into containers/trucks for their transport in an ocean leg/intermodal supply chain regularly. Certain load plan engines try to maximize the filled volume in a container using a standard greedy heuristic or specific methods that can take care of constraints on a single attribute. There is a need for solution(s) for problems that are beyond the scope of a greedy heuristic/exact solution methods for load planning problems with constraints on a single attribute.

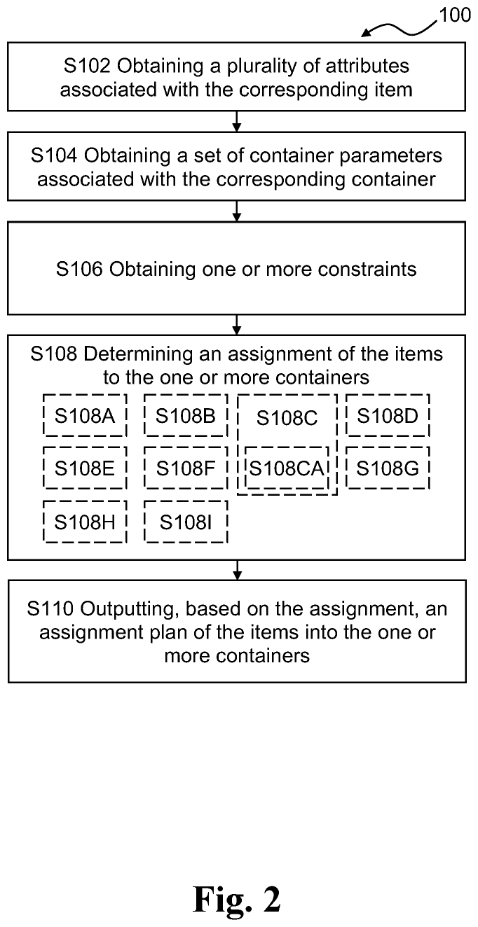

FIG. 2 shows a flow diagram of an exemplary method, performed by an electronic device, for assigning items into one or more containers according to the disclosure.

The method 100 comprises obtaining S102 a plurality of attributes associated with a corresponding item. For example, a set of items comprising: item I_1, item I_2, . . . item I_N, where N is an integer, wherein each item has attributes, e.g. item I_1 has attributes comprising: attribute A_1_1, attribute A_1_2, . . . , attribute A_1_M, where M is an integer. In one or more example methods, the attributes comprise one or more of: a shipping order, a purchase order, a date of arrival at origin warehouse, an origin port, a destination port, a plant code, an expected time of arrival. In one or more example methods, the attributes comprise one or more of: a cargo type, a stoke keeping unit, a vendor attribute, a volume of the cargo, and a weight of the cargo. For example, bookings of items (e.g. cargo bookings) may comprise a list of attributes associated with items. For example, the attributes may specific information about the item (e.g. cargo) such as shipping order (SO) number, purchase order (PO) number, date of arrival at origin warehouse, origin port, destination port, plant code, expected time of arrival (ETA), category and type of cargo, stoke keeping unit (SKU), vendor name or code, volume and weight of the cargo, and so on. For example, an item or cargo can have e.g. 34-36 fields of information saved as attributes when the items reach the CFS for the consolidation process.

The method 100 comprises obtaining S104 a set of container parameters associated with a corresponding container. The set of container parameters may comprise one or more container parameters. In one or more example methods, the set of container parameters comprises one or more of: a volume of the container, a residual capacity of the container, and a maximum capacity of the container.

The method 100 comprises obtaining S106 one or more constraints, such as one or more constraints on more than one attribute of the plurality of attributes (such as on at least two attributes of the plurality of attributes). Optionally, a plurality of constraints comprising a first constraint and a second constraint may be obtained. The one or more constraints limit assigning one or more items in a same container. A constraint may be associated with an item, and/or with the container comprising the item (e.g. when the item is placed in the container). In other words, a constraint may be on a plurality of attributes in the present disclosure. For example, a constraint may be seen as a permissible limit of item attributes in a container.

In an illustrative example where the disclosed technique is applied to demonstrate the use of constraints (e.g. conflict sets), where the number of different stock keeping units (SKUs) per container is limited. It is assumed that we have 6 items, P={p1, p2, p3, p4, p5, p6} belonging to three types of SKUs in the following order: SKU 1={p1, p2, p3}, SKU 2={p4, p5}, SKU 3={p6}. A packing constraint that limits the container to hold items belonging to only 2 SKU types (dsKU=2) is considered. For example, the attribute under consideration, a={‘SKU’} and the unique attribute label set are Cₐ={SKU 1,SKU 2, SKU 3}. The item sets are as follows, where SKUs are referred to as Groups:

| CsKU | Pc | \|Pc\| |
|---|---|---|
| Group 1 | {p1, p2, p3}, | 3 |
| Group 2 | {p4, p5} | 2 |
| Group 3 | {p6} | 1 |

For example, the set Csku consists of three groups whose items belong to the subset Pc. Column |P_{c}| represents number of items in each group. For this example, Constraints illustrated in Equation (6) of the mathematical model for any j belonging to T can be represented as follows:

x_{1,j}+x_{2,j}+x_{3,j}≤3.w_{c1,j}

x_{4,j}+x_{5,j}≤2.w_{c2,j}

x_{6,j}≤1.w_{c3,j} (1)

Constraints illustrated in Equation (7), which sets an upper bound on the number of groups that are allowed to be in a single bin, are:

w_{c1,j}+w_{c2,j}+w_{c3,j}≤d_{SKU},∀j∈T (2)

For example, the model considers three constraints per container to the allocation of specific SKUs in a container along with an additional constraint that limits the maximum number of distinct SKUs (by an upper bound, dsKU—2 for this example) that can be put in a container.

In the disclosed equations, T denote a set of containers, R denotes Resource types, P denotes a set of items, A denotes a set of attributes of item, Ca denotes a set of unique attribute labels for a chosen attribute a belonging to A, Pc ⊆P denotes a set of items sharing the value c ∈ Ca of attribute a. In the disclosed equations, the parameters are as follows: Qi denotes a cost in currency of container j, Vj,r denotes a capacity of containerj for resource type r, v_{i,r} denotes a utilisation of resource type r through item i, da denotes an upper bound on the number of different values of attribute a that can allocated to a single container. In the disclosed equations, the variables are as follows: yⱼ ∈{0, 1} denotes a variable indicating whether container j is used, x_{i,j} ∈ {0,1} denotes a variable indication whether item i is allocated to container j, w_{c,j} ∈ {0,1} denotes a variable indicating whether value c ∈ Ca of attribute a is present in container j,

An illustrative example where the present technique is applied, assuming P as the set of items with a volume (in cubic meters) and a list of attributes associated with corresponding items, T as the set of containers available for packing items, where each container has cost Q (in dollars) and a maximum capacity V (in cubic meters). The constraints may provide conflict sets (that limit the number of different values of items) on attributes in a single container.

Let A be a set of relevant item attributes and C_a the set of unique values for attribute a.

A partition of item set P is done into disjoint subsets {P_c}, such that each of the partition contains items sharing the same attribute value of c. {P_c} may represent a non-overlapping partition of P into subsets such that each of the subset contains items belonging to the unique chosen attribute a in the attribute set A. |P_c| denotes the number of items sharing the attribute value. Parameter d_a defines how many different attributes values can occur in a single container concurrently. The objective of the optimization problem is to assign all items to one or more containers while minimizing total bin costs so that no conflicts between items occur and no constraints are violated.

Binary variables x_{i,j} are used to assign item i\in P to container(s) j\in T and y_j indicated whether bin j is used in the solution.

Binary variable w_{g,j} indicates whether any item of conflict group g's attribute value is present in container j. The model can be then formulated as follows e.g.:

$$min {\sum }_{j ∈ T} {q}_{j} {y}_{j} \qquad ( 3 )$$

$$s . t . {\sum }_{j ∈ T} {x}_{i , j} = 1 ∀ i ∈ P \qquad ( 4 )$$

$${\sum }_{i ∈ P} {v}_{i , r} {x}_{i , j} \leq {V}_{j , r} {y}_{j} ∀ j ∈ T , r ∈ R \qquad ( 5 )$$

$${\sum }_{i ∈ {P}_{c}} {x}_{i , j} \leq \vert {P}_{c} \vert {w}_{c , j} ∀ a ∈ A , c ∈ {C}_{a} , j ∈ T \qquad ( 6 )$$

$${\sum }_{c ∈ {C}_{a}} {w}_{c , j} \leq {d}_{a} ∀ a ∈ A , j ∈ T \qquad ( 7 )$$

$${x}_{i , j} ∈ \{ 0 , 1 \} , ∀ i ∈ P , j ∈ T \qquad ( 8 )$$

$${w}_{c , j} ∈ \{ 0 , 1 \} , ∀ a ∈ A , c ∈ {C}_{a} , j ∈ T , \qquad ( 9 )$$

$${y}_{j} ∈ \{ 0 , 1 \} , ∀ j ∈ T \qquad ( 10 )$$

The objective function (3) minimizes the total cost of used containers after assigning of all items in the set P. For example, the disclosed technique may be seen as a compact formulation of the optimization problem as a mixed integer program.

Constraints illustrated in Equation (4) ensure that each item is assigned to exactly one container.

Constraints illustrated in Equation (5) ensure that the capacity of container j in respect to resource type r is respected by summing the total resource utilization of items assigned to the container.

Constraints illustrated in Equations (6) and (7) limit the mix of items in the same container. Constraints illustrated in Equations (6) and (7) may be seen as conflicting with constraints illustrated in Equation (4) and/or (5).

Specifically, Constraints illustrated in Equation (6) sets the indicator variable w_{c,j} to 1 if any item with attribute value c is assigned to container j. Indicator variable _{c,j} may for example take value 0 or 1 for indicating whether an item having the constrained attributed is assigned to bin j.

Constraints illustrated in Equation (7) set an upper bound on the number of different attribute values that can be together in a single container. Finally, 8, 9, 10 may be seen as defining the variable domains.

The method 100 comprises determining S108 an assignment of the items to the one or more containers, based on the attributes (e.g. corresponding to the items), the set of container parameters and the one or more constraints.

In one or more example methods, the one or more constraints are associated with the plurality of attributes (e.g. attributes of one or more items already placed in a given container). For example, the one or more constraints are on the attributes of an item to be placed in the container. For example, the one or more constraints may be placed on the attributes by the customer. It may be seen that many constraints are associated with a container in a load plan based on the attributes of the items placed in a container.

In one or more example methods, determining S108 the assignment of the items to the one or more containers comprises determining S108A whether attributes associated with a first item violates the one or more constraints. For example, determining S108A may comprise determining whether the assignment of an item violates a set of constraints associated with the permissible limits of attributes in the container, such as first container.

In one or more example methods, determining S108 the assignment of the items to the one or more containers comprises upon determining that the attributes associated with the first item (such as denoted as first attributes associated with the first item) do not violate the one or more constraints, assigning S108B the first item to a first container (e.g. the first available container). For example, the method comprises repeating the process S108 until all items are assigned.

For example, constraints may be seen as conditions that need to be honoured (e.g. not violated) by the load planning process. There may be many constraints that need to be honoured (e.g. not violated). For example, when considering assignment of item having as attribute the same destination (e.g. items that go to the same destination, e.g. in a city), and as attribute the same vendor in one container, two constraints may be imposed e.g.: a first constraint may limit to one vendor per container, and the second constraint may limit one destination per container. For example, a violation of the constraints may take place when it is determined that items having different destinations as attributes are assigned to the same container. For example, a violation of the constraints may take place when it is determined that items having different vendors as attributes are assigned to the same container. For example, the constraints (e.g. one vendor per container, e.g. one destination per container) can be seen as conditions that need to be met by items to be assigned the container.

The method 100 comprises outputting 3110, based on the assignment, an assignment plan of the items into the one or more containers. For example, the assignment plan may be seen as a load plan.

Advantageously, the disclosed method enables to assign all items to containers while minimising total container cost so that no conflicts between items occur and no capacity constraints are violated. The disclosed technique is easy to implement and configure, and delivers the output in e.g. seconds. It is implemented into a product to generate a feasible solution in a reasonable time (e.g. 30 minutes) for all the practical scenarios in current shipping and logistic freight forwarding processes.

In one or more example methods, determining S108 the assignment of the items to the one or more containers comprises optimizing S108C a set of performance parameters indicative of shipping performance based on the attributes, the set of container parameters and the constraints. For example the shipping performance may comprise container cost. For example, optimizing S108C the set of performance parameters may comprise reducing the container cost.

In one or more example methods, optimizing S108C the set of performance parameters comprises applying S108CA, to an item set and a container set, an assignment scheme with a plurality of counters indicative of the corresponding constraints placed on the attributes of the corresponding items. For example, item set comprises the items, and the container set comprises the one or more containers. For example the assignment scheme may comprise a scheme based on approximation algorithms (such as a fit decreasing scheme) and/or strategies. For example, the assignment scheme may comprise a scheme based on e.g. a first fit decreasing scheme, a next fit decreasing scheme, a best fit decreasing scheme. For example, with respect to the heuristic algorithm for the model, the assignment scheme (e.g. First Fit Decreasing, FFD, strategy) can be replaced with an alternate scheme of Best Fit Decreasing (which is computationally extensive and increase the runtime) or a Next Fit Decreasing scheme (which does not order items and it delivers an inferior solution compared to FFD). An FFD scheme may comprise ordering of items based on volume and ordering of the containers based on cost per volume. It may be appreciated that the FFD scheme comprises the iterative assignment of highest volume items to lowest cost container until all items are assigned to containers.

For example, the assignment scheme may be based on a generalization of next-fit-decreasing (NFD) algorithm with multiple counters to honour the constraints placed on the attributes of item (e.g. FFD with Conflicts, FFDC).

In one or more example methods, the set of performance parameters comprises one or more performance parameters indicative of cost associated with the one or more containers, and/or a capacity associated with the one or more containers. For example, the capacity comprises a maximum capacity associated with the one or more containers, such as of each container.

In one or more example methods, determining S108 the assignment of the items to the one or more containers comprises determining S108D, for each item, and based on the attributes associated with the item (such as with that item), whether the item fits into a residual capacity of a container of the one or more containers (e.g. the current container), without violating the constraints.

In one or more example methods, determining S108 the assignment of the items to the one or more containers comprises when it is determined that the item fits into the residual capacity of the container without violating the constraints, assigning S108E the item to the container (e.g. the first container). For example, the item is added to the set of items assigned to the current container when it is determined that the item fits into the residual capacity of the container without violating the constraints.

In one or more example methods, determining S108 the assignment of the items to the one or more containers comprises when it is not determined that the item fits into the residual capacity of the container without violating the constraints, forgoing S108F (e.g. refraining from assigning the item to the container, e.g. not assigning the item to the container) the assignment of the item to the container (e.g. the first container). For example, the item is not added to the set of items assigned to the current container when it is not determined that the item fits into the residual capacity of the container without violating the constraints.

In one or more example methods, determining S108 the assignment of the items to the one or more containers comprises determining S108G a number of conflicts in a container.

In one or more example methods, determining S108 the assignment of the items to the one or more containers comprises determining S108H whether the number of determined conflicts satisfy a criterion. For example the criterion may be seen as condition set on the buffers of items for the iterative assignment. For example, S108H may be expressed by Equation (11), where the second line in equation 11 checks that the upper bounds da for all attributes hold by summing the number of unique values Ca for attribute a. The criterion may be based on a threshold, such as upper bound da. For example, determining S108H whether the number of determined conflicts satisfy the criterion comprises determining whether the number of determined conflicts is less than a pre-defined threshold. In other words, the criterion is satisfied when the number of determined conflicts is less than a pre-defined threshold. For example, the conflicts are related to the violating of the constraints. For example, when it is determined that the number of determined conflicts does not satisfy the criterion, the method comprises terminating the process. For example, when it is determined that the number of determined conflicts satisfy the criterion, the method comprises continue to assign items.

For example, the assignment process S108 may be illustrated by initializing the set of container-item tuples holding the solution. For example, the container T and the item set P are sorted and indexed in descending order of the volume parameter v (utilization) and V (capacity) respectively, such that the lowest indexed items have the highest values. For example a set of counters are set depending upon the number of conflicts that need to be honoured while assigning the items.

There may be a Boolean function defined which returns true, if item fits into the residual capacity of the current container without violating conflict rules. If no constraints are violated, the container-item assignment is added to the solution, the residual capacity vector is updated and the assigned item removed from the set of items to be processed. For example, the process repeats until all items of P are assigned to bins. For example, a post-processing can be performed to further refine the load plan for any possible reduction of the empty space in containers. A re-assessment of the load plan is performed if a nearest smaller bin can accommodate an already assigned item volume in a container (provided smaller containers are still available). Otherwise, the FFDC scheme may returns the current solution.

In one or more example methods, determining S108 the assignment of the items to the one or more containers comprises upon determining that attributes associated with the first item violate the first constraint and/or the second constraint, assigning S1081 the first item to a container other than the first container.

FIG. 3 shows a block diagram of an exemplary electronic device 300 according to the disclosure. The electronic device 300 comprises a memory circuitry 301, a processor circuitry 302, and an interface 303. The electronic device 300 is configured to perform any of the methods disclosed in FIG. 2. In other words, the electronic device 300 is configured for providing an assignment of items into one or more containers (e.g. a load plan).

The electronic device 300 is configured to obtain, via the interface 303 and/or the processor circuitry 302, a plurality of attributes associated with the corresponding item.

The electronic device 300 is configured to obtain, via the interface 303 and/or the processor circuitry 302, obtain a set of container parameters associated with the corresponding container.

The electronic device 300 is configured to obtain, via the interface 303 and/or the processor circuitry 302, obtain one or more constraints. The one or more constraints limits assigning items in a same container.

The electronic device 300 is configured to determine, via the processor circuitry 302, an assignment of the items to the one or more containers, based on the attributes, the set of container parameters and the constraints.

The electronic device 300 is configured to output, via the interface 303 and/or the processor circuitry 302, based on the assignment, an assignment plan of the items into the one or more containers

The processor circuitry 302 is optionally configured to perform any of the operations disclosed in FIG. 2 (such as any one or more of: S108A, S108B, S108C, S108CA, S108D, S108E, S108F, S108G, S108H, S1081). The operations of the electronic device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the electronic device 300 may be considered a method that the electronic device 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 3). The memory circuitry 301 is considered a non-transitory computer readable medium.

The memory circuitry 301 may be configured to store the assignment plan, or load plan in a part of the memory.

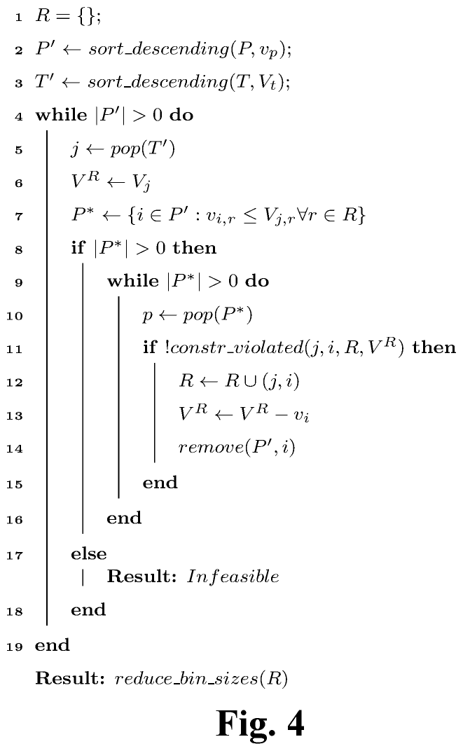

FIG. 4 is an illustration of an exemplary method according this disclosure presented as scheme. The illustrated scheme is based on a Mixed Integer Programming Model and a heuristic Method FFDC, e.g. with pseudocode for practical implementation.

The containers T and the item set P are sorted and indexed in descending order of the volume parameter v (utilisation) and V (capacity) respectively such that the lowest indexed items have the highest values.

The while loop in line 4 loops while there are still items to be assigned to a container. Starting with the largest container, line 6 initialises the residual capacity to its total capacity and selected items P* that fit into the container. If |P *| is empty, this means that |P|>0 but no item is fitting into the largest container. Thus, the algorithm returns an Infeasible state (line 17). Next, loop in line 9 tries to assign items while constraints are not validated. Function constr violated (j, i, R, V^{R})→{true, false} for container j, item i, solution R and residual capacity vector V R is defined as follows:

$$constr\_violated ( j , i , R , {V}^{R} ) = ∀ r ∈ R : {V}_{r}^{R} - {v}_{i , r} \geq 0 ∧ \qquad ( 11 )$$

$$∀ a ∈ A : {d}_{a} \geq {\sum }_{c ∈ {C}_{a}} \{ \begin{matrix}0 , if {P}^{′′} ⋂ {P}_{c} = ∅ \\ 1 , else\end{matrix}$$

with P″={i′: (j′,i′) ∈ R: j′=j} ∪{i}. The boolean function 11 returns true, if item i fits into the residual capacity VrR for all of resource types r and whether the conflict sets are not violated. Therefore, P″ defines the set of items currently assigned to container j. The second line in equation 11 checks that the upper bounds da for all attributes hold by summing the number of unique values Ca for attribute a. Attribute value c ∈ Ca appears in container j, if the intersection between items already associated to containers P″ and items with that property PC is not empty.

If no constraints are violated, line 12 adds the container-item assignment to the solution, updates the residual capacity vector and removes i from the items to be processed. Note that we assume the pop operates to remove items for the lists. The process repeats until all items of P′ are assigned to containers. Post assignment of all items to containers, a post-processing is done in line 19. Function reduce container sizes (R) refines the load plan for further reduction of the empty space in containers. It re-assesses the load plan if a nearest smaller container can accommodate an already assigned item volume in a containers (provided smaller containers are still available). Otherwise, FFDC algorithm returns the current load plan.

Embodiments of methods and products (electronic device) according to the disclosure are set out in the following items:

Item 1. A method, performed by an electronic device, for assigning items into one or more containers, the method comprising:
obtaining (S102) a plurality of attributes associated with a corresponding item;
obtaining (S104) a set of container parameters associated with a corresponding container;
obtaining (S106) one or more constraints, wherein the one or more constraints limit assigning items in a same container; and
determining (S108) an assignment of the items to the one or more containers, based on the attributes, the set of container parameters and the one or more constraints; and
outputting (S110), based on the assignment, an assignment plan of the items into the one or more containers.

Item 2. The method according to item 1, wherein the one or more constraints are associated with the plurality of attributes.

Item 3. The method according to any of the previous items, wherein determining (S108) the assignment of the items to the one or more containers comprises:
determining (S108A) whether attributes associated with a first item violates the one or more constraints,
upon determining that the attributes associated with the first item do not violate the one or more constraints, assigning (S108B) the first item to a first container.

Item 4. The method according to any of the previous items, wherein determining (S108) the assignment of the items to the one or more containers comprises:
optimizing (S108C) a set of performance parameters indicative of shipping performance based on the attributes, the set of container parameters and the constraints.

Item 5. The method according to item 4, wherein optimizing (S108C) the set of performance parameters comprises applying (S108CA), to an item set and a container set, an assignment scheme with a plurality of counters indicative of the corresponding constraints placed on the attributes of the corresponding items.

Item 6. The method according to any of the previous items, wherein the set of performance parameters comprises one or more performance parameters indicative of cost associated with the one or more containers, and/or a capacity associated with the one or more containers.

Item 7. The method according to any of the previous items, wherein the attributes comprise one or more of: a shipping order, a purchase order, a date of arrival at origin warehouse, an origin port, a destination port, a plant code, an expected time of arrival, a cargo type, a stoke keeping unit, a vendor attribute, a volume of the cargo, and a weight of the cargo.

Item 8. The method according to any of items 1-7, wherein the set of container parameters comprises one or more of: a volume of the container, a residual capacity of the container, and a maximum capacity of the container.

Item 9. The method according to any of the previous items, wherein determining (S108) the assignment of the items to the one or more containers comprises:
determining (S108D), for each item, and based on the attributes associated with the item, whether the item fits into a residual capacity of a container of the one or more containers, without violating the constraints.

Item 10. The method according to item 9, wherein determining (S108) the assignment of the items into the one or more containers comprises:
when it is determined that the item fits into the residual capacity of the container without violating the constraints, assigning (S108E) the item to the container.

Item 11. The method according to any of items 9-10, wherein determining (S108) the assignment of the items to the one or more containers comprises:
when it is not determined that the item fits into the residual capacity of the container without violating the constraints, forgoing (S108F) the assignment of the item to the container.

Item 12. The method according to any of the previous items, wherein determining (S108) the assignment of the items to the one or more containers comprises:
determining (S108G) a number of conflicts in a container; and
determining (S108H) whether the number of determined conflicts satisfy a criterion.

Item 13. The method according to any of items 3-12, wherein determining (3108) the assignment of the items to the one or more containers comprises:
upon determining that attributes associated with the first item violate the one or more constraints, assigning (S1081) the first item to a container other than the first container.

Item 14. An electronic device comprising a memory circuitry, a processor circuitry, and an interface, wherein the electronic device is configured to perform any of the methods according to any of items 1-13.

Item 15. A computer readable storage medium storing one or more programs, the one or more programs comprising instructions, which when executed by an electronic device with a display and a touch-sensitive surface cause the electronic device to perform any of the methods of any of items 1-13.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and may not be intended to denote any specific spatial or temporal ordering. Furthermore, in one or more embodiments, the labelling of a first element may not imply the presence of a second element and vice versa.

It may be appreciated that FIGS. 1-4 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method, performed by an electronic device, for assigning items into one or more containers, the method comprising:
obtaining a plurality of attributes associated with a corresponding item;
obtaining a set of container parameters associated with a corresponding container;
obtaining one or more constraints, wherein the one or more constraints limit assigning items in a same container;
determining an assignment of the items to the one or more containers, based on the attributes, the set of container parameters and the one or more constraints; and
outputting, based on the assignment, an assignment plan of the items into the one or more containers.

2. The method according to claim 1, wherein the one or more constraints are associated with the plurality of attributes.

3. The method according to claim 1, wherein determining the assignment of the items into the one or more containers comprises:
determining whether attributes associated with a first item violates the one or more constraints,
upon determining that the attributes associated with the first item do not violate the one or more constraints, assigning the first item to a first container.

4. The method according to claim 1, wherein determining the assignment of the items into the one or more containers comprises:
optimizing a set of performance parameters indicative of shipping performance based on the attributes, the set of container parameters and the constraints.

5. The method according to claim 4, wherein optimizing the set of performance parameters comprises applying, to an item set and a container set, an assignment scheme with a plurality of counters indicative of the corresponding constraints placed on the attributes of the corresponding items.

6. The method according to claim 1, wherein the set of performance parameters comprises one or more performance parameters indicative of cost associated with the one or more containers, and/or a capacity associated with the one or more containers.

7. The method according to claim 1, wherein the attributes comprise one or more of: a shipping order, a purchase order, a date of arrival at origin warehouse, an origin port, a destination port, a plant code, an expected time of arrival, a cargo type, a stoke keeping unit, a vendor attribute, a volume of the cargo, and a weight of the cargo.

8. The method according to claim 1, wherein the set of container parameters comprises one or more of: a volume of the container, a residual capacity of the container, and a maximum capacity of the container.

9. The method according to claim 1, wherein determining the assignment of the items into the one or more containers comprises:
determining, for each item, and based on the attributes associated with the item, whether the item fits into a residual capacity of a container of the one or more containers, without violating the constraints.

10. The method according to claim 9, wherein determining the assignment of the items into the one or more containers comprises:
when it is determined that the item fits into the residual capacity of the container without violating the constraints, assigning the item to the container.

11. The method according to claim 9, wherein determining the assignment of the items into the one or more containers comprises:
when it is not determined that the item fits into the residual capacity of the container without violating the constraints, forgoing the assignment of the item to the container.

12. The method according to claim 1, wherein determining the assignment of the items to the one or more containers comprises:
determining a number of conflicts in a container; and
determining whether the number of determined conflicts satisfy a criterion.

13. The method according to claim 3, wherein determining the assignment of the items to the one or more containers comprises:
upon determining that attributes associated with the first item violate the one or more constraints, assigning the first item to a container other than the first container.

14. An electronic device comprising a memory circuitry, a processor circuitry, and an interface, wherein the electronic device is configured to:
obtain a plurality of attributes associated with a corresponding item;
obtain a set of container parameters associated with a corresponding container;
obtain one or more constraints, wherein the one or more constraints limit assigning items in a same container;
determine an assignment of the items to the one or more containers, based on the attributes, the set of container parameters and the one or more constraints; and
output, based on the assignment, an assignment plan of the items into the one or more containers.

15. A computer readable storage medium storing one or more programs, the one or more programs comprising instructions, which when executed by an electronic device with a display and a touch-sensitive surface cause the electronic device to:
obtain a plurality of attributes associated with a corresponding item;
obtain a set of container parameters associated with a corresponding container;
obtain one or more constraints, wherein the one or more constraints limit assigning items in a same container;
determine an assignment of the items to the one or more containers, based on the attributes, the set of container parameters and the one or more constraints; and
output, based on the assignment, an assignment plan of the items into the one or more containers.
